(19) United States
(12) Patent Application Publication
(10) Pub. No.: US 2007/0156693 A1
(43) Pub. Date: Jul. 5, 2007

(54) OPERATING SYSTEM ROLES

(75) Inventors: Ravipal S. Soin, Redmond, WA (US); Vinay Krishnaswamy, Redmond, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: MICROSOFT CORPORATION, Redmond, WA (US)

(21) Appl. No.: 11/556,221

(22) Filed: Nov. 3, 2006

Related U.S. Application Data
(60) Provisional application No. 60/733,180, filed on Nov. 4, 2005.

(51) Int. Cl. G06F 17/30

(52) U.S. Cl. 707/9

(57) ABSTRACT

Operating system roles may be defined to provide users access to computer resources, such as files, computer setup and configuration tasks, application programs and specific features within applications, separately from the permissions associated with the user's login. Permission levels may be designated directly to roles, providing a level of abstraction beyond user login access permissions. Thus, role members may gain access to a resource through the permissions of a role, and similarly, other authorized users will not be denied access to a resource based on a change to the role.

### CROSS-REFERENCE TO RELATED APPLICATION

The present application claims priority to U.S. provisional patent application, Ser. No. 60/733,180, filed Nov. 4, 2005, having the same title, whose contents are expressly incorporated by reference.

### BACKGROUND

Computer file systems that exist today implement access control security on files and folders individually, thus allowing a user to be isolated from another user while accessing the same file system. For example, a first file may have security settings that permit only user A to access the first file. This security setting on the first file allows another user B to use the same file system without the concern that user B will wrongfully access the first file. The ability to isolate users on the same file system results in privacy of files. There is an array of permissions that can correspond to files and folders, such as read, write, and execute permissions. Also, if users desire, users can choose to change the security permissions on their files and folders to allow other users any of the array of permissions.

On the WINDOWS® brand operating system by Microsoft Corporation of Redmond, Wash., this security architecture is managed through an Access Control List (ACL). An ACL effectively states what rights various users have for a particular file or folder. These rights include, read, write, execute, modify, and security permissions, among others. For instance, a user might not be allowed to view a given file at all; or, the user may only be able to read the file; or, the user may be given rights to modify the file; or, the user may be given rights to change the ACL of the file, etc. There is a full spectrum of ACL permissions beyond those mentioned. The default permission on a given item may be inherited from the permissions of the folder in which it was created. Additionally, when a folder is shared with another user, thus changing its permissions, the operating system may iterate through all the files beneath that folder and apply the change to the ACL for each file in the shared folder.

A problem with this model is that the ACL on any given item is based on a user ID. The ACL states that user1 has access permission to the file or folder, but the reason for the grant of that permission is not provided in the ACL. Also, when removing permissions for a group of files, it is impossible to determine whether a permission for a particular file should remain because it was or would have been granted for a reason independent from that which concerns the group of files having the permission removed. If user1 has been given permission to access filel because of reason1 and reason2, when reason1 becomes void and the access permission for user1l is removed, it is impossible to realize from the ACL whether the permission should be retained because of reason2.

The Windows® XP brand operating system also allows for the creation of “groups,” which consist of a set of users and/or other groups. Once created, a group can be used within an ACL, which makes it easier to apply permissions to many users at once. Though a useful tool, the group utility still requires that individual user IDs be created; groups do not themselves have any permission inherently associated with them.

The above security model can be tedious to set up and maintain. Universities and schools in emerging markets typically do not have large IT support departments, and thus security is often less than optimal in such environments. Thus, it is difficult to establish a security plan based on roles performed by each user. In addition, the above security architecture does not provide an efficient mechanism through which users with different roles can have access to different features altogether.

### SUMMARY

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the present invention relate to an operating system capable of providing and restricting user access to resources on the computer system. According to one aspect, an operating system role is defined on the computer system, which designates a level of permissions to certain resources on the computer. For example, permissions on files, the instantiation of programs and specific features within the programs, computer setup functions, and multi-tasking capability on the computer may be designated to a role and available to any users that are members of the role. When a user requests access to the resource, the system may provide access based on determinations that the user is a member of the role, and that the permissions on the role are designated to allow access to the requested resource, even though the user might not have permission to access the same resource through his user login. For example, the operating system may store both security permissions and feature permissions for the role as an access control list (ACL) corresponding to an application installed on the computer. Thus, through operating system roles, even though a user's login is not represented in the ACL, the user may be granted access alternatively through the role.

According to another aspect of the present invention, permissions on operating system roles and conventional user logins may be reassigned independently. For example, if a role on a computer system allows a user to access a resource, but the user has previously been granted access to the same resource independently through her user login, then revocation of access through the role need not affect the existing access permissions associated with the user login. Thus, when an operating system role is updated to remove a user, the system need not unnecessarily revoke the user's access to resources for which she was independently granted (i.e., through her user login). Similarly, if an operating system role is updated to no longer control access to certain resources, then users that have been granted access independently of the role may still be able to access the resources.

According to yet another aspect of the present invention, roles may be defined by the operating system or by an application installed on the system. Additionally, custom roles may be defined and updated by an administrator on the system. In one example, roles are used in an operating system configured for educational or classroom use. Different roles may be defined for students, instructors, administrators, class monitors, and others in the learning environment. In this example, the system may enable or disable resource access based on roles. For instance, portions of teacher calendars, specific shared folders for collaboration, content in the school virtual library, upcoming events, and other information on the system may be conveniently and consistently permissioned based on operating system roles.

### BRIEF DESCRIPTION OF THE DRAWINGS

The foregoing summary, as well as the following detailed description, is better understood when read in conjunction with the accompanying drawings, which are included by way of example, and not by way of limitation and in which like reference numerals indicate similar elements.

FIG. 1 illustrates an operating environment in which one or more illustrative aspects of the invention may be performed.

FIG. 2 is a flow chart showing an illustrative technique for providing access to computer resources using operating system roles, according to aspects of the present invention.

FIGS. 3A-3C are block diagrams illustrating stored permissions for an application using an operating system role, according to aspects of the present invention.

FIGS. 4-8 are screenshots of user interface views from an illustrative education system using operating system roles, according to aspects of the present invention.

### DETAILED DESCRIPTION

In the following description of the illustrative aspects, reference is made to the accompanying drawings, which form a part hereof, and in which is shown by way of illustration various aspects and embodiments in which the invention may be practiced. It is to be understood that other aspects and embodiments may be utilized and structural and functional modifications may be made without departing from the scope of the present invention.

Illustrative Operating Environment

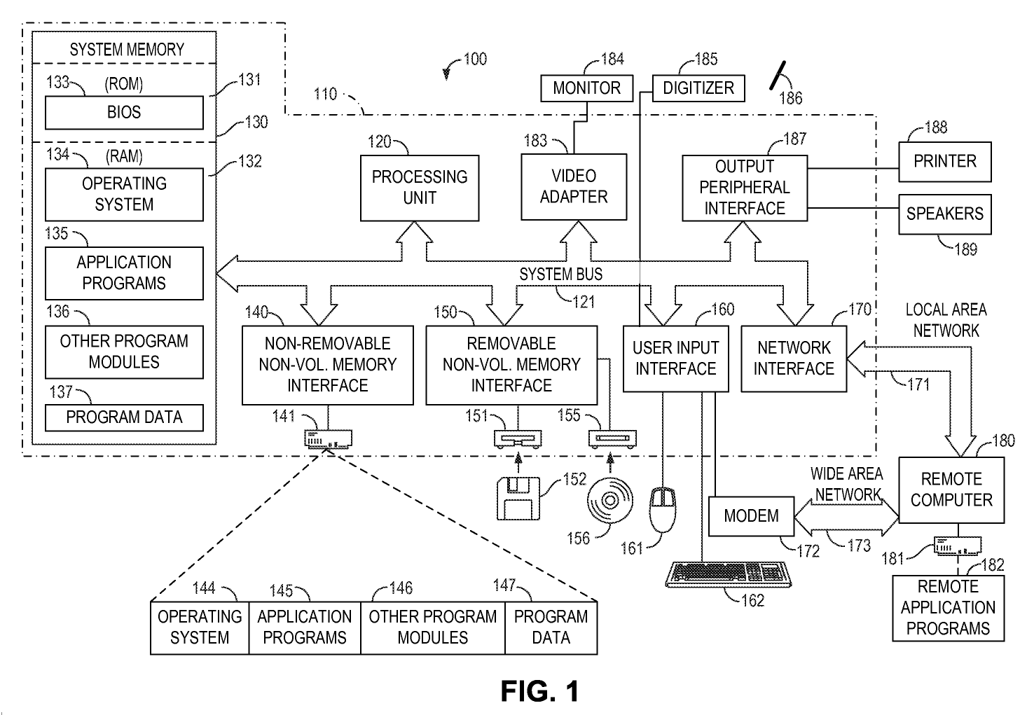

FIG. 1 illustrates an example of a suitable computing environment 100 in which a roles-based operating system may be implemented. The computing environment 100 is only one example of a suitable computing environment and is not intended to suggest any limitation as to the scope of use or functionality of any aspect of the invention. Neither should the computing environment 100 be interpreted as having any dependency or requirement relating to any one or combination of components illustrated in the exemplary operating environment 100.

Aspects of the invention are operational with numerous other general purpose or special purpose computing system environments or configurations. Examples of well known computing systems, environments, and/or configurations that may be suitable include, but are not limited to, personal computers; server computers; portable and hand-held devices such as personal digital assistants (PDAs), tablet PCs or laptop PCs; multiprocessor systems; microprocessor-based systems; set top boxes; programmable consumer electronics; network PCs; minicomputers; mainframe computers; game consoles; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

With reference to FIG. 1, an illustrative system for implementing aspects of the invention includes a general purpose computing device in the form of a computer 110. Components of computer 110 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, DVD or other optical disk storage, magnetic cassettes, magnetic tape, magnetic disk storage or other magnetic storage devices, or any other medium which can be used to store the desired information and which can accessed by computer 1 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 13 1. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, DVD, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 1 10. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port, universal serial bus (USB), or IEEE 1394 serial bus (FireWire). At least one monitor 184 or other type of display device may also be connected to the system bus 121 via an interface, such as a video adapter 183. The video adapter 183 may support advanced 3D graphics capabilities, in addition to having its own specialized processor and memory. Computer 110 may also include a digitizer 185 to allow a user to provide input using a stylus input device 186. In addition to the monitor, computers may also include other peripheral output devices such as speakers 189 and printer 188, which may be connected through an output peripheral interface 187.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 may be connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 1 10, or portions thereof, may be stored in the remote memory storage device. By way of example, and not limitation, FIG. 1 illustrates remote application programs 182 as residing on memory device 181. It will be appreciated that the network connections shown are exemplary and other means of establishing a communications link between the computers may be used.

One or more aspects of the invention may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

### ILLUSTRATIVE EMBODIMENTS

Aspects of the present invention may be used to provide a roles-based operating system. In such a system, individual users need not receive individual login IDs (although they may if desired, e.g., to monitor attendance, separate file storage, etc.). Instead, each user logs in with a role, where the feature and security permissions of the user are defined by the user's role, not his or her user ID. Security permissions may affect file storage areas to which the user has access, and feature permissions may determine whether the role has access to features such as application programs, media players, sidebar widgets, interactive media rich presentation applications, Wellspring, messaging, etc. Aspects described herein may be incorporated in an operating system on desktop computers, laptop computers, tablet PCs, or any other computer device which uses an operating system.

An illustrative aspect of the invention provides operating system roles in an educational environment where IT support is typically minimal, and administration is performed by non-IT personnel or by personnel with minimal IT experience. The roles-based operating system may be branded with the educational institution's logo to foster school spirit. Educational roles might include a Student role, where the PC is locked down with tight security, an Instructor role, through which an instructor can perform classroom management and instruction, and an Administrator role, through which IT management can be easily performed (e.g., due to low IT support levels in educational environments). Custom roles may also be created by the Administrator, as needed. For example, a Class Monitor role may be created where each class has a particular aide or student that helps oversee projects. A Team Captain role may be created where student participate in a project in groups, and the Team Captain is responsible for additional activities, such as submitting results. Thus, roles can be used as the mechanism through which functionality in applications built into the computer is extended to users.

Thus, the operating system may enable/disable information access based on roles, such as portions of a teacher calendars, specific shared folders, portions of a portal, digital content in a school's virtual library, important upcoming events, etc. Roles also allow teachers and administrators to manage content (e.g., subscriptions and in-house learning content) in a leveraged manner.

As described above, the stored permissions may correspond to other resources on a computer 110 besides files stored in the file system. For example, operating systems may define and store ACL permissions for computer setup functions, such as enabling or disabling the computer restart and lock down functions, and disabling or limiting a user's multi-tasking capability (i.e., running multiple application windows concurrently on the terminal). Additionally, ACLs may be stored corresponding to specific features of application programs installed on the computer 1 10. Of course, if an application is not pre-installed with the operating system, but installed at a later time, then the application may be required to provide relevant information to the operating system (e.g., feature names and descriptions, a recommended level of permissions for different users and roles).

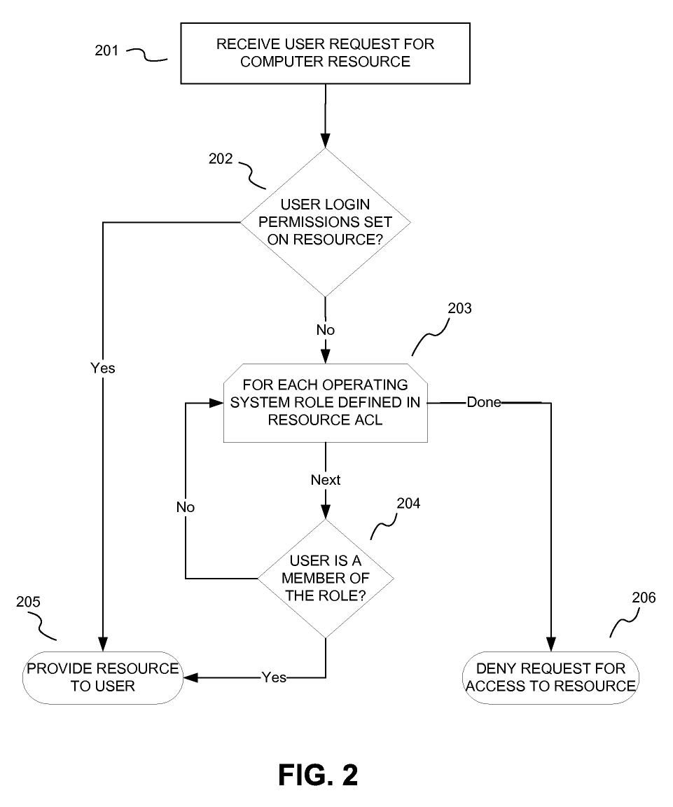

Referring to FIG. 2, an illustrative process is shown for providing access to resources on a computer 110 using operating system roles. In step 201, a request is made for user permission information, for example, as a user attempts to access a file or application feature on the computer 110. In the flow chart of FIG. 2, a resource request may incorporate both the resource on the computer 110, and the level of access that the user is requesting. Thus, if a user attempts to write to a file in the file system, this may be considered a request for write-access permissions on the file. Similarly, if a user attempts to execute (e.g., instantiate) an application on the computer 110, this may be considered a request for execute-access permissions on the application program.

In step 202 the access control database is searched to determine if the user has the appropriate set of permissions to access the resource. For example, an access control list (ACL) stored on the operating system for the requested resource may be read to determine if an identifier associated with the user (e.g., the user's login, or an identifier referencing the user in a user table) is present in the file's ACL. If the appropriate permission is found in the ACL, indicating that the user has access to the requested resource (202: Yes), then in step 205 the application may provide the resource or otherwise inform the user/invoking function that the user does have access to the requested resource.

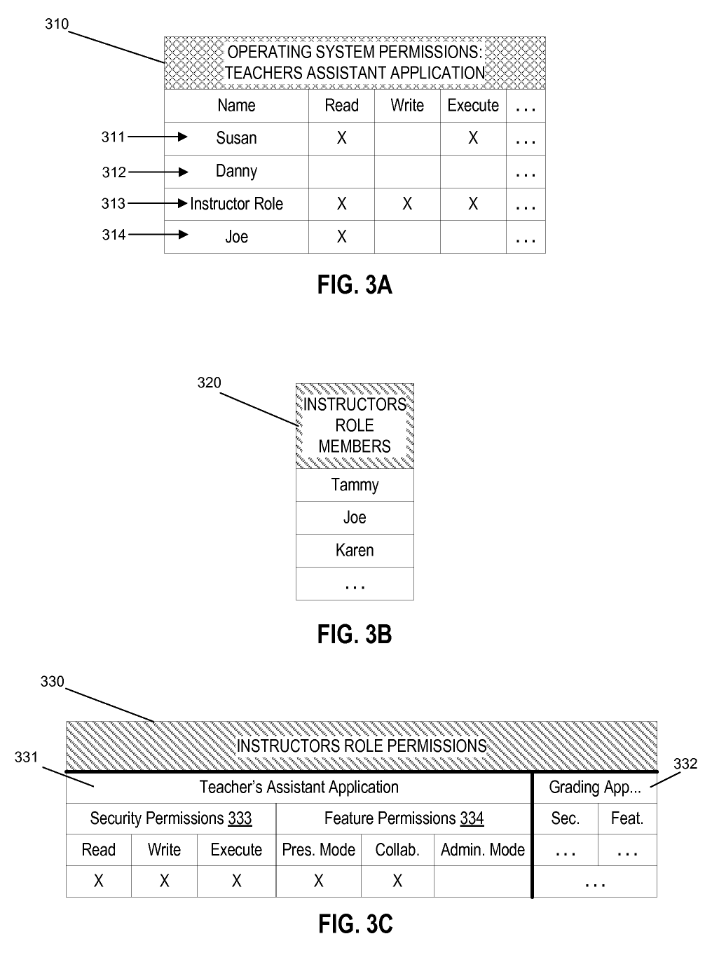

Of course, the operating system may determine that the correct ACL permissions are not set to allow the user access to the requested resource (202: No). This is illustrated briefly in reference to FIG. 3A. If the access request of step 201 corresponds to the user Danny 312 attempting to read from the Teacher's Assistant application, then the condition in step 202 will fail since Danny has no permissions at all on the application. Similarly, if the access request of step 201 corresponds to the user Joe 314 attempting to execute the application, then condition in step 202 will fail since Joe has only read, but not write or execute permissions on the Teacher's Assistant application.

In step 203, having determined that the individual user permission is not set in the ACL, each operating system role for which the appropriate permission is set in the ACL may be examined to determine if the requested user has access to the resource through the role. For example, referring again to FIG. 3A, if the access request of step 201 corresponds to the user Joe 314 attempting to execute the Teacher's Assistant application, then even though Joe's user login/user ID is not represented (by an “X” in this example) in the requested ACL permission, the Instructors role 313 may be examined in step 204 to determine if Joe is a member. Thus, since the Instructors role does have execute permissions on the Teacher's Assistant application (see FIG. 3A), and since Joe is a member of the Instructors role (see FIG. 3B), then Joe will be provided access to the resource in step 205. However, if Danny, for example, requested access to the application, then because Danny's user login is not represented in the ACL for the application (see FIG. 3A), and he is not a member of the Instructors role (see FIG. 3B), then Danny would be denied access to the resource at step 206.

With references to FIGS. 3A-3C, an illustrative set of tables defining access permissions are diagrammatically shown for the Teacher's Assistant application. Using these example tables, several additional aspects of the present invention will be discussed.

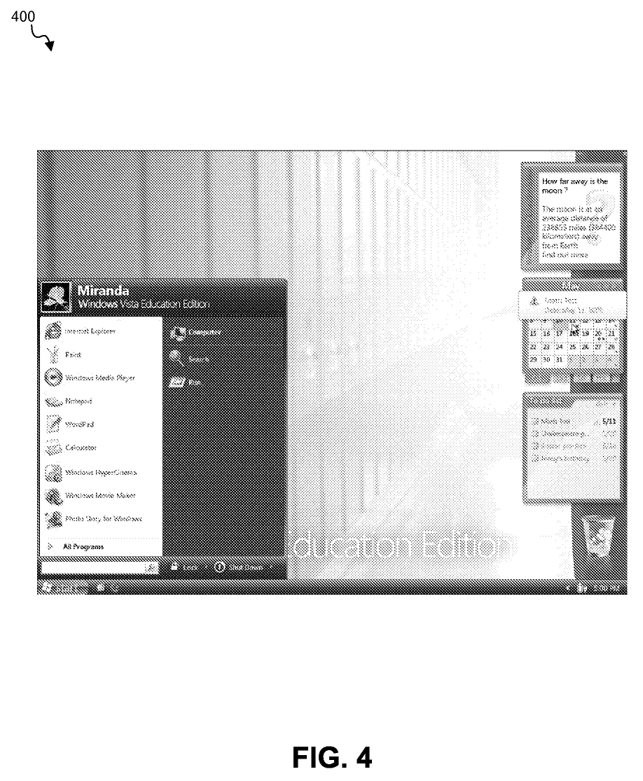

Table 310 in FIG. 3A shows an illustrative ACL permissions table for the Teacher's Assistant application. Specifically, this ACL permissions table 310 may correspond to the executable file that launches the Teacher's Assistant application. As shown in table 3 10, the users Susan 311, Danny 312, and Joe 314 are designated various permissions with respect to the application. Additionally, an operating system role, Instructor Role 313, is provided with read, write, and execute permissions on the application. As shown in FIGS. 4-8 described below, the operating system in this example may be designed and/or configured for a specific type of use (i.e., educational classroom use). Thus, the Instructors role, and other operating system roles related to classroom applications, may be pre-installed onto the operating system along with a set of software applications that use these roles. Alternatively, operating system roles may be installed concurrently with an application that uses those roles. For example, a version of Teacher's Assistant application designed for subsequent installation (i.e., after the OS installation) onto a more general use operating system may provide its roles to the operating system during the application setup process, allowing the system to integrate these new roles into the existing ACL permissions tables. Similarly, multiple applications that use the same roles may be installed on a computer 1 10. Thus a new application installed onto a computer 110 with an existing set of applicable roles may only need to provide the set of security and feature permissions to the operating system, defining the permissions that each existing role should have with respect the new application.

Table 320 in FIG. 3B defines the members of the Instructors role. While this members list is implemented as a separate table in this example, it may also be joined into the same structure defining role permissions (e.g., table 330 in FIG. 3C). This information might also be stored separately for each role member, for example, in the operating system user accounts information, rather than in a centralized table 320. Additionally, as stated above, a member in an operating system role might have permissions on a computer resource both as a member of that role, and through a second set of permissions granted independently of the role. For example, in table 310, the user Joe 314 has been granted read permissions on the Teacher's Assistant application. However, by virtue of Joe's membership in the Instructors role, Joe also has write and execute permissions on the application. Thus, if Joe were removed from the Instructors role, he would lose his write and execute permissions on the application, but would not lose his independently-granted read permissions.

Of course, the role list 320 may be updated so that it consistently reflects the current set of users designated for the role. The operating system may provide this updating capability, for example, by leveraging existing functionality and user interfaces for managing user groups. However, since operating system roles may relate directly to one or more applications, then the applications themselves may provide a user interface for adding and removing members from the different roles used by that application.

Table 330 in FIG. 3C defines a set of permissions for the Instructors role. As shown in table 330, a single role may have both security permissions 333 and feature permissions 334 defined for one or more different applications 331 and 332. The security permissions 333 for the role may be identical to the corresponding set of security permissions in the ACL permissions table 310. In fact, it may be possible to combine the two tables 310 and 330, so that only one set of security permissions for the Teacher's Assistant application is stored. Alternatively, these tables may be maintained separately, and may even define different sets of permissions. For example, the role permissions table 330 may store additional types of permissions information not stored in the ACL permissions table 310 (e.g., permissions regarding multi-tasking support while using the application). Additionally, the values of certain permissions in the role permissions table 330 might differ from a corresponding value in the ACL table 3 10. In one example, it might be necessary for the execute permission to be granted in both tables 310 and 330 before a member of the Instructors role would be permitted to instantiate the application. Thus, this potential replication of data may allow the application an additional technique for setting and maintaining access control for its associated roles.

The role permissions table 330 also contains feature permissions 334 defined for the Instructors role on the applications 331 and 332. The feature permissions data may relate to specific functionality (e.g., different screens, user interface components, etc.) in the application, to which the operating system is unaware. In this example, a member of the Instructors role is granted access to the Presentation Mode and Collaboration features of the Teacher's Assistant application. As described below, members of different roles (e.g., Students) might not be granted permissions to these same features.

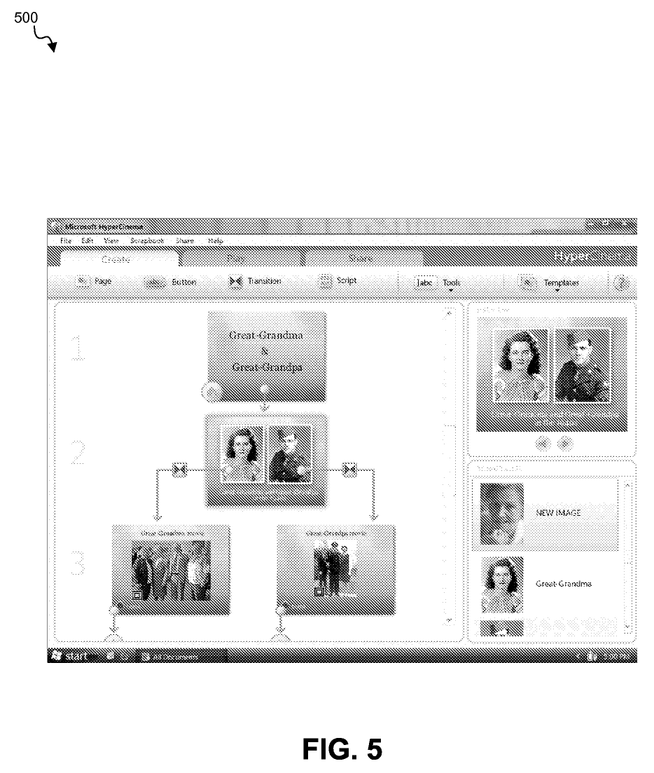

With reference to FIGS. 4 and 5, illustrative user interface views 400 and 500 are shown, demonstrating functionality that may provided for a Student role in a computer system configured for educational classroom user. As introduced above, each role has various associated feature and security permissions. One illustrative example will now be described. As shown in views 400 and 500, the Student role may provide strict access restrictions so that students do not tamper with or alter the setup of the computer. That is, in the Student role the PC is locked down while the student still has access to simple media tools at the forefront. FIG. 4 illustrates a sample screenshot of a Student role PC locked down to only school-approved apps. For example, the Student role may indicate that the computer is locked down with Shared Computer Toolkit functionality. The Student role may include access to media tools such as interactive media rich presentations, scanning, DVD, media player, and the like. The Student role may also include a peer-to-peer (P2P) meeting space application for education-centric file-sharing and collaboration (while preventing cheating). Also, the Student role may include easy access to information, e.g., using the Encarta BOT built on the Messenger platform, where students ask questions and get answers in an Instant Messenger window.

The media components in a Student role are rich and diverse, as so much of schoolwork now is working with information. FIG. 5 illustrates an Interactive media rich presentation—a concept that blends concept-mapping with the leverage of the operating system's (e.g., Windows® Vista) video capabilities, and leveraging MovieMaker, to help Students create simple branching presentations including video, still images (w/ ‘Ken Burns’ effects) and music. Thus, the Student role may provide great, simple media tools (scanning, DVD, Windows Media Player); file-sharing and collaboration; information at your fingertips with robust search of rich encyclopedia content, among other features.

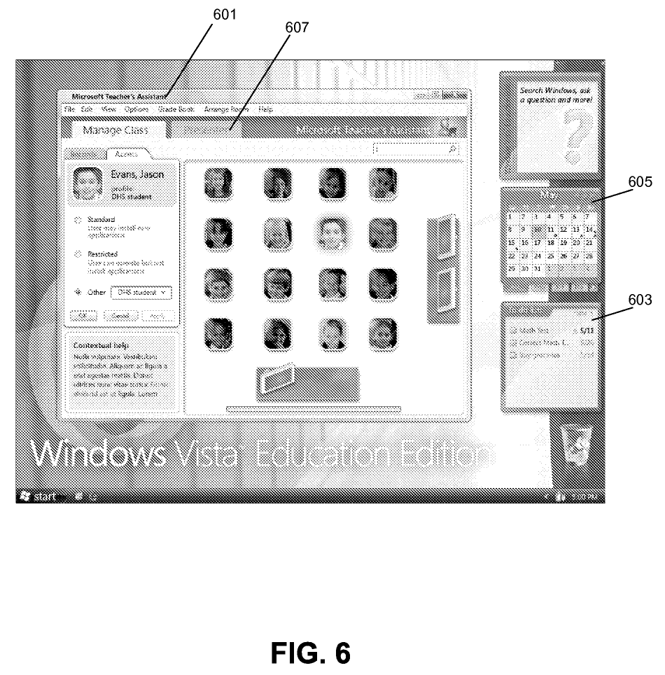

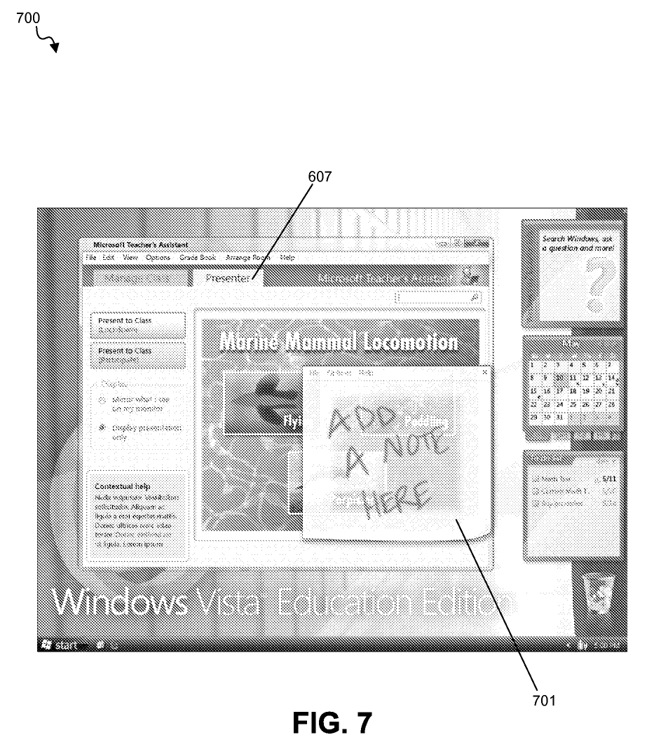

With reference to FIGS. 6 and 7, illustrative user interface views 600 and 700 are shown, demonstrating functionality that may be provided for an Instructor role of the Teacher's Assistant application described above. In this example, an Instructor role may be a limited or least-privileged user account (LUA) in a Windows® brand Vista operating system, while retaining some level of classroom PC administration via Group Policy, such as allowing USB flash keys or applications on Student PCs. The Instructor role may provide access to operate certain features of the Teacher's Assistant application 601, for example, to view, lockdown, and intervene on Student role classroom instructional PCs, as well as to project the instructor screen on all classroom PCs on which a Student role is active.

The Instructor role may have an included presentation mode 607 which is presentation friendly, including, e.g., a ten (10) foot user interface and presentation adaptability to easily or automatically turn off notifications, screen blanking when presenting, etc. The Instructor role may include sidebar widgets for Instructors, such as a lesson plan widget, a tasks widget 603, a calendar widget 605, etc. The Instructor role may also have access to media tools, communication tools (e.g., the instructor can push alert/messages to specific roles, users, groups, etc.), Sticky Notes 701 (from Mobility, for fast annotation/note-taking). Variations of an Instructor role may include access to a built-in RFID reader or peripheral device, through which attendance may be taken. Attendance may alternatively be taken by an RFID reader on each PC at student seating locations, or by Login. Interactive tutorials may be included to instruct the instructor how to effectively use the Instructor role. Thus, the Instructor role may provide a console to view, lock down, and intervene on student classroom instructional PCs, as well as to project the instructor screen on all classroom PCs. Instructor role may also allow teachers to present information without any interruptions, and provide educational specific interactive tutorials on PC usage and administration.

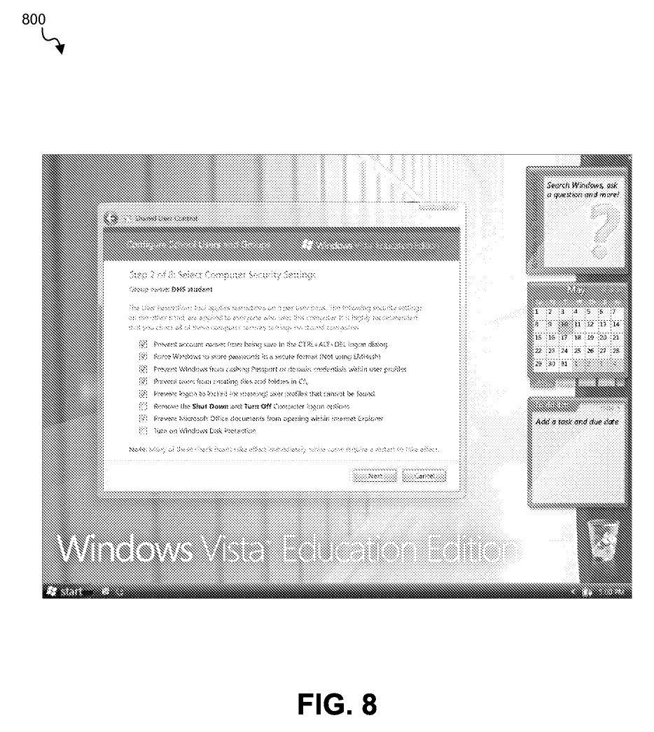

With reference to FIG. 8, an illustrative user interface view 800 is shown, demonstrating functionality that may be provided for an Administrator role, for example, designated for information technology professionals. As shown in view 800, the Administator role may provide a workstation profile manager through which a user can simply and easily perform configuration of roles and policies, an application library manager to leverage software restriction policies, a OneCare integration application to provide integration with OneCare for ease of servicing, backup utilities, and disk quota management. The Administrator role may also support LDAP/Passport as well as AD for Identity, Internet blocking and/or filtering, and may include Deployment Tools to use smart hardware detection (e.g., sniffing) to install Vista, XP w/ Shared Toolkit, or Eiger depending on the hardware configuration.

Thus, aspects described above may be incorporated into a low-priced operating system for the educational institutions to create higher quality learning experiences for their students through increased collaboration, interaction, and visual stimulation; as well as more effective information-sharing methods. Aspects of the operating system simplify administration for low IT-support schools, give teachers management control over student PCs allowing for lockdown of shared student PCs, and work with a wide range of software, hardware, and services including support for many older applications designed for earlier versions of Windows. Aspects will serve to increase students' confidence to learn and study efficiently by using technology that allows them to be more organized with a simplified user experience.

Various aspects and optional features may include the ability to restrict multitasking (e.g., by restricting alt-tab toggling, or preventing alt-tab toggling among no more than four concurrent application windows), avoid distraction in the classroom and provide at a glance information for upcoming events, task management, and persistent data view for due dates and school events. Students and instructors can collaborate by students posting their work online, and then allowing instructors to make comments on the work and sketch other ideas to consider. The operating system may take advantage of Tablet PC features such as the use of Ink data structure. The operating system allows users to harness the power of Tablet PC's. Everything that used to weigh down backpacks—notebooks, computer, research, calculators, pens and highlighters, calendar, music and music players—fits easily in a Tablet PC. A user can switch the tablet to Tablet mode for a slim, mobile machine, e.g., quickly jotting down a reminder as the user walks to her next class, or can take notes naturally on those tiny desks in lecture halls.

While illustrative systems and methods as described herein embodying various aspects of the present invention are shown, it will be understood by those skilled in the art, that the invention is not limited to these aspects and embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive.

We claim:

1. One or more computer readable media storing computer-executable instructions which, when executed on a computer system, perform a method comprising steps of:
(a) identifying a first role on the computer system, the first role associated with one or more resources on the computer system and one or more users of the computer system;
(b) receiving a request from a first user to access a first resource on the computer system;
(c) determining that the first user is a member of the first role;
(d) determining that the first resource is associated with the first role;
(e) based on (c) and (d), permitting the first user to access the first resource.

2. The computer readable media according to claim 1, wherein the first resource is a set of privileges corresponding to a subset of features of a first application installed on the computer system.

3. The computer readable media according to claim 2, wherein a second role associated with one or more different users is defined on the computer system, the second role providing a set of privileges corresponding to a different subset of features of the first application.

4. The computer readable media according to claim 1, wherein at the time step (e) is performed, the first user is not permitted to access the first resource through an assigned user login corresponding to the first user.

5. The computer readable media according to claim 4, wherein an access control database is stored on the computer system, said database defining access permissions to the first resource, and wherein at the time step (e) is performed the user login assigned to the first user is not represented in the access control database.

6. The computer readable media according to claim 1, wherein the first resource is a set of privileges corresponding to the instantiation of an application program on the computer system.

7. The computer readable media according to claim 1, wherein the first resource is a set of privileges corresponding to control over the number of application programs that are allowed to be run concurrently by a user on the computer system.

8. The computer readable media according to claim 1, wherein the first resource is one of a file stored on a file system in the computer system.

9. The computer readable media according to claim 1, wherein the first resource is a set of privileges corresponding to control over the setup of the computer.

10. One or more computer readable media storing computer-executable instructions which, when executed on a computer system, perform a method of providing access to a resource on a computer system, the method comprising:
identifying a first role on the computer system, the first role associated with one or more resources on the computer system;
identifying a first user of the computer system;
granting the first user access to a first resource on the computer system through use of a user login;
configuring the first role to permit the first user to access the first resource through use of the first role; and
reconfiguring the first role to prevent the first user from accessing the first resource through the first role, wherein the reconfiguring of the first role does not prevent the first user from accessing the first resource through use of the user login.

11. The computer readable media according to claim 10, wherein the reconfiguring of the first role comprises removing the first user from a list of members associated with the first role.

12. The computer readable media according to claim 10, wherein the reconfiguring of the first role comprises disassociating the first resource from the first role, and wherein after said reconfiguring the first user remains a member of the first role.

13. The computer readable media according to claim 10, the method further comprising:
identifying a second role on the computer system, the second role associated with a different set of one or more resources on the computer system, wherein the first resource is associated with both the first and second role;
configuring the first role to permit the first user to access the first resource through use of the first role;
configuring the second role to permit the first user to access the first resource through use of the second role; and
reconfiguring the second role to prevent the first user from accessing the first resource through the second role, wherein the reconfiguring of the second role does not prevent the first user from accessing the first resource through use of the first role.

14. A system for providing access to a computer resource, comprising:
a storage for storing access permissions associated with a plurality of computer resources;
one or more input devices configured to receive user input;
a processor controlling at least some operations of the system; and
a memory storing computer executable instructions that, when executed by the processor, cause the system to perform a method comprising:
storing in the storage a first set of access permissions corresponding to a first role, the first role associated with a first user and a computer resource;
receiving user input from an input device, said user input corresponding to a request by the first user to access the computer resource;
determining that the first user is associated with the first role;
retrieving from the storage the first set of access permissions; and
granting the first user access to the computer resource based on the first set of access permissions.

15. The system of claim 14, the method further comprising the steps of:
storing in the storage a second set of access permissions corresponding to a second role, the second role associated with a second user;
receiving user input from an input device, said user input corresponding to a request by the second user to access the computer resource; and
denying the second user access to the computer resource based on a determination that the second user is not associated with the first role.

16. The system of claim 15, wherein the step of denying the second user access to the computer resource is further based on a determination that the second user is not permitted to access the computer resource through an assigned user login for the second user.

17. The system of claim 14, wherein at the time that the first user is granted access to the computer resource, the first user is not permitted to access the first resource through an assigned user login for the first user.

18. The system of claim 14, wherein the computer resource corresponds to a subset of features of an application installed on the computer system.

19. The system of claim 18, wherein the first role provides a set of access permissions corresponding to a subset of features of the application, and wherein the second role provides a set of access permissions corresponding to a different subset of features of the application.

20. The system of claim 18, wherein computer resource comprises one of a privilege to instantiate an application on the system, a privilege to control the number of applications that are allowed to run concurrently by a user on the system, and a privilege to control a setup function of the computer.
